(19) United States
(12) Patent Application Publication
(10) Pub. No.: US 2024/0259871 A1
(43) Pub. Date: Aug. 1, 2024

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/692,147

(22) PCT Filed: Sep. 15, 2021
(86) PCT No.: PCT/CN2021/118569

§ 371 Date: Mar. 14, 2024

(51) Int. Cl. H04W 28/06; H04W 28/02; H04W 72/231

(52) U.S. Cl. CPC H04W 28/06; H04W 28/0268; H04W 72/231

(57) ABSTRACT

According to embodiments, solutions on UL packet dropping are proposed. A terminal device determines a set of data packets to be transmitted to a network device. The terminal device transmits information to the network device. The information indicates a buffer status report of the set of data packets and a packet delay budget associated with the buffer status report. In this way, it avoids transmitting out-of-date data, thereby avoiding wasting resources.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For some communication services, requirements on latency are very critical. For example, some data may be useless if the transmission of the data is delayed. In addition, when a new data arrives in an uplink (UL) buffer. A terminal device may transmit a buffer status report (BSR) to a network device. The Buffer Status reporting procedure is used to provide the serving network device with information about the amount of data available for transmission in the UL buffer.

### SUMMARY

In general, example embodiments of the present disclosure provide a solution for communication.

In a first aspect, there is provided a method for communication. The communication method comprises: determining, at a terminal device, a first set of data packets to be transmitted to a network device; and transmitting, to the network device, information indicating: a first buffer status report (BSR) of the first set of data packets and a first delay budget associated with the first BSR.

In a second aspect, there is provided a method for communication. The communication method comprises: receiving, at a network device and from a terminal device, information indicating: a first buffer status report (BSR) of a first set of data packets and a first delay budget associated with the first BSR, wherein the first set of data packets are to be transmitted by the terminal device.

In a third aspect, there is provided a method for communication. The communication method comprises: determining, at a terminal device, a first set of data packets to be transmitted to a network device; in accordance with a determination that a portion of the first set of data packets needs to be dropped based on a delay budget or a higher layer indication for the first set of data packets, causing the portion of the first set of data packets to be dropped.

In a fourth aspect, there is provided a terminal device. The terminal device comprises a processing unit; and a memory coupled to the processing unit and storing instructions thereon, the instructions, when executed by the processing unit, causing the terminal device to perform acts comprising: determining, at a terminal device, a first set of data packets to be transmitted to a network device; and transmitting, to the network device, information indicating: a first buffer status report (BSR) of the first set of data packets and a first delay budget associated with the first BSR.

In a fifth aspect, there is provided a network device. The network device comprises a processing unit; and a memory coupled to the processing unit and storing instructions thereon, the instructions, when executed by the processing unit, causing the network device to perform acts comprising: receiving, at a network device and from a terminal device, information indicating: a first buffer status report (BSR) of a first set of data packets and a first delay budget associated with the first BSR, wherein the first set of data packets are to be transmitted by the terminal device.

In a sixth aspect, there is provided a terminal device. The terminal device comprises a processing unit; and a memory coupled to the processing unit and storing instructions thereon, the instructions, when executed by the processing unit, causing the terminal device to perform acts comprising: determining, at a terminal device, a first set of data packets to be transmitted to a network device; in accordance with a determination that a portion of the first set of data packets needs to be dropped based on a delay budget or a higher layer indication for the first set of data packets, causing the portion of the first set of data packets to be dropped.

In a seventh aspect, there is provided a computer readable medium having instructions stored thereon, the instructions, when executed on at least one processor, causing the at least one processor to carry out the method according to any one of the first aspect, or second aspect, or third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIGS. 3A-3E illustrate schematic diagrams of buffer status report (BSR) medium access control (MAC) control element (CE) according to some embodiments of the present disclosure;

FIG. 4 illustrates a signaling flow for communications according to some embodiments of the present disclosure;

FIG. 5 illustrates a schematic diagram of packet dropping according to some embodiments of the present disclosure;

FIG. 6 illustrates a schematic diagram of packet dropping according to some embodiments of the present disclosure;

FIG. 7 illustrates a schematic diagram of packet dropping according to some embodiments of the present disclosure;

FIG. 8 illustrates a schematic diagram of packet dropping according to some embodiments of the present disclosure;

FIG. 9 illustrates a schematic diagram of packet dropping according to some embodiments of the present disclosure;

FIG. 10 illustrates a schematic diagram of packet dropping according to some embodiments of the present disclosure;

FIG. 11 is a flowchart of an example method in accordance with an embodiment of the present disclosure;

FIG. 12 is a flowchart of an example method in accordance with an embodiment of the present disclosure;

FIG. 13 is a flowchart of an example method in accordance with an embodiment of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, requirements on latency are very critical. Enhancements on UL packet dropping for Virtual Reality (VR) and Augmented Reality (AR) (can be collectively referred to as “XR”) traffics are needed. The characters of XR traffic are simple summarized as following: high throughput (10 Mbps˜50 Mbps), high reliability (99%˜99.999%), low latency (PDB=10 ms˜60 ms), periodicity. For XR, packet size is typically large, considerable resources may be wasted if the out-of-date packets are still transmitted. Packet dropping may need cross layer design, i.e., gNB/UE needs to know a packet delay budget (PDB) and the boundary of an XR application frame. For downlink (DL) scheduling, packet dropping may be an implementation issue, UE does not need to know whether gNB dropped some packets, at least in the lower layer (i.e., medium access control (MAC) and physical (PHY)). For UL scheduling, gNB has to know whether UL packets should be dropped and whether the UL resource assignments are still needed.

Moreover, in current new radio (NR) specification, a BSR shall be triggered if any of the following events occur: (1) UL data, for a logical channel which belongs to an LCG, becomes available to the MAC entity; (2) UL resources are allocated and number of padding bits is equal to or larger than the size of the Buffer Status Report MAC CE plus its subheader; (3) retxBSR-Timer expires, and at least one of the logical channels which belong to an LCG contains UL data; (4) periodicBSR-Timer expires.

5G Quality of Service (QoS) characteristics describe the packet forwarding treatment that a QoS Flow receives edge-to-edge between the UE and the UPF in terms of the following performance characteristics: resource type (Guaranteed Bit Rate (GBR), Delay critical GBR or Non-GBR); priority level; packet delay budget (PDB); packet error rate (PER); averaging window (for GBR and Delay-critical GBR resource type only); maximum data burst volume (MDBV) (for Delay-critical GBR resource type only).

The term “Packet Delay Budget (PDB)” used herein defines an upper bound for the time that a packet may be delayed between the UE and the N6 termination point at the user plane function (UPF). The PDB applies to the DL packet received by the UPF over the N6 interface, and to the UL packet sent by the UE. For a certain 5G QoS Identifier (5QI) the value of the PDB is the same in UL and DL. In the case of 3GPP access, the PDB is used to support the configuration of scheduling and link layer functions (e.g. the setting of scheduling priority weights and HARQ target operating points). For Guaranteed GBR (QoS flows using the delay-critical resource type, a packet delayed more than PDB is counted as lost if the data burst is not exceeding the MDBV within the period of PDB and the QoS Flow is not exceeding the GFBR. For GBR QoS Flows with GBR resource type not exceeding GFBR, 98 percentage of the packets shall not experience a delay exceeding the 5QI's PDB. The 5G Access Network Packet Delay Budget (5G-AN PDB) is determined by subtracting a static value for the Core Network Packet Delay Budget (CN PDB), which represents the delay between any N6 termination point at the UPF (for any UPF that may possibly be selected for the PDU Session) and the 5G-AN from a given PDB. PDB of an XR traffic burst can refer to the delay budget from the time that an XR traffic burst arrives at gNB/UE to the time that all the data packets (or X % of data packets, wherein X is a number between 0 and 100) of the XR traffic burst are successfully transmitted. An XR traffic burst may comprise one or more data packets. As an example, the data packets of an XR traffic burst may contain correlated information, e.g., each of the data packets may contain a part of the information of a video frame which is generated by an XR application. In this case, the data packets may have same requirements of delay budget. If the data packets of the XR traffic burst do not arrive at gNB/UE at the same time, then the arrival time of the XR traffic burst could be defined as the arrival time of the first packet or the last packet or the average arrival time of the data packets of the XR traffic burst.

To enable packet dropping, file boundary (i.e., the beginning and ending of the packets belong to a same XR traffic burst) and the associated PDB need to be known by scheduler. For a specific logical channel, gNB/UE may determine that the packets with similar arrival time and same PDB requirement belongs to a same XR traffic burst, or just determine that by, e.g., headers of application data units (ADUs). The term “application data unit (ADU)” used herein can refer to a minimum granularity of application data for processing. An ADU may be packetized into one or more internet protocol (IP) packets and then delivered to gNB/UE. In an embodiment, the data packets of an XR burst may contain information of an ADU. Scheduler should strive to transmit all the packets successfully within the PDB. However, it is still possible that some of the packets cannot be transmitted in time. For UL scheduling, gNB may draw the maximum PDB based on the QoS parameter of the UL traffic. However, gNB cannot exactly know the remaining PDB of an XR traffic burst, since gNB does not know the exact time that an UL packet arrives at UE.

According to embodiments, solutions on UL packet dropping are proposed. A terminal device determines a set of data packets to be transmitted to a network device. The terminal device transmits information to the network device. The information indicates a buffer status report of the set of data packets and a delay budget associated with the buffer status report. In this way, it avoids transmitting out-of-date data, thereby avoiding wasting resources.

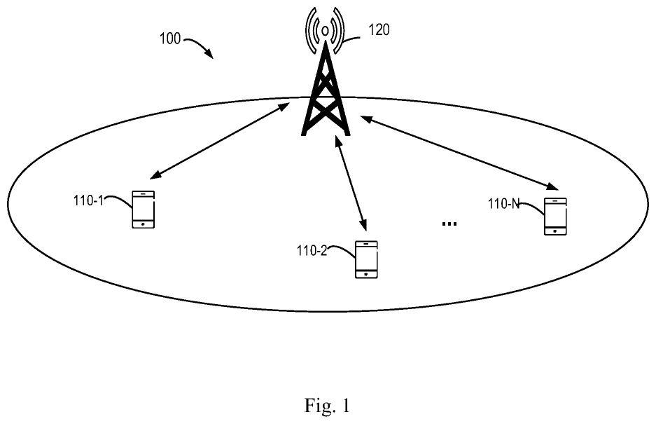

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In the communication system 100, the network device 120 and the terminal devices 110 can communicate data and control information to each other. The numbers of terminal devices and network devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols. The term “symbol” may refer to Orthogonal Frequency Divided Multiple (OFDM) symbol or Discrete Fourier Transform-spread-OFDM (DFT-s-OFDM) symbol.

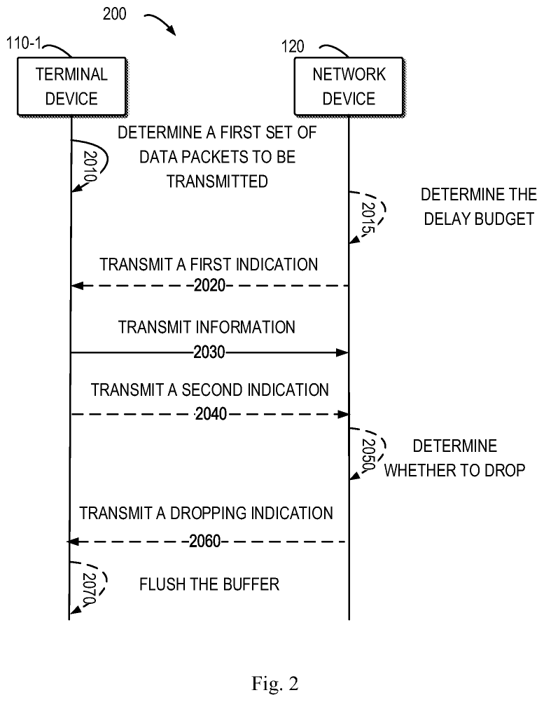

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1.

The network device 120 may have information about a service or application at the terminal device 110-1. For example, the network device 120 may obtain detailed traffic characteristics from a core network or an application server.

The terminal device 110-1 determines 2010 a first set of data packets to be transmitted to the network device 120. The first set of data packets may belong to an XR traffic burst or an ADU. The first set of data packets may comprise any suitable number of data packets. The terminal device 110-1 may receive the first set of data packets from a higher layer, for example, MAC layer. In some embodiments, the data packet may be an ADU. Alternatively, the data packet may be an internet protocol (IP) packet. The data packet may be a radio link control (RLC) protocol data unit. Alternatively, the data packet may be a RLC service data unit (SDU). In other embodiments, the data packet may be a MAC PDU or a MAC SDU. The data packet may also be a transport block (TB). In addition, the data packet may be a code block group (CBG). In some embodiments, the data packet may be a scheduling unit.

In some embodiments, the network device 120 may determine 2015 a delay budget of the XR traffic burst. In some embodiments, the delay budget may be a PDB. The PDB can represent a delay budget for one or more packets. In some embodiments, the delay budget may be an air interface PDB or 5G-AN PDB. The air interface PDB or 5G-AN PDB can represent a delay budget for one or more packets at the radio access network. Alternatively, the delay budget may be an ADU delay budget (ADB). The ADB can represent a delay budget for an ADU. For example, the network device 120 may determine the delay budget based on the UL QoS parameters. The delay budget may be the maximum delay budget. In some embodiments, the delay budget may be per QoS flow. Alternatively, the delay budget may be per logical channel.

The terminal device 110-1 transmits 2030 information to the network device 120. The information indicates a first BSR of the first set of data packets. The first BSR may indicate the data volume of the first set of data packets. In addition, the information indicates a first delay budget associated with the first BSR. The first delay budget may be a remaining delay budget for the first set of data packets. The remaining delay budget for the first set of data packets may be the time duration from the time that the information is transmitted to the latest time that the first set of data packets are expected to be successfully transmitted. The information may be transmitted in a MAC CE. The time that the information is transmitted is the time of the first symbol or last symbol of a transmission which contains the information. In addition, the first set of data packets may be transmitted in a logical channel.

In some embodiments, as shown in FIG. 2, the network device 120 may transmit 2020 a first indication to the terminal device 110-1. The first indication may inform the terminal device 110-1 to transmit the delay budget. In this case, the terminal device 110-1 may transmit/report the first BSR with the first delay budget, i.e., the information indicates the first BSR and the first delay budget. Alternatively, if the terminal device 110-1 does not receive the first indication, the terminal device 110-1 may transmit/report the BSR only. In some embodiments, the first indication can be transmitted in a MAC CE. Alternatively or in addition, the first indication can be transmitted in downlink control information (DCI).

In some embodiments, the terminal device 110-1 may determine that a second set of data packets to be transmitted to the network device 120. In this case, the information may also indicate a second BSR of the second set of data packets and a second delay budget associated with the second BSR. The second delay budget may be a remaining delay budget for the second set of data packets. The remaining delay budget for the second set of data packets may be the time duration from the time that the information is transmitted to the latest time that the second set of data packets are expected to be successfully transmitted. In other words, the terminal device 110-1 may report multiple BSRs associated with multiple XR traffic bursts respectively, and each of the multiple BSRs is associated with a delay budget. In this situation, the information may indicate a first identity of the first BSR or a first identity of first delay budget. The information may also indicate a second identity of the second BSR or a second identity of the second delay budget. For example, the information may comprise a BSR ID or a delay budget ID to identify multiple XR traffic burst with different delay budgets. The information can explicitly indicate the first identity and/or the second identity. Alternatively, the information may implicitly indicate the first identity and/or the second identity. In this case, the network device 120 may explicitly determine the first identity of the first BSR or first delay budget and the second identity of the second BSR or second delay budget based on the information. Alternatively, the network device 120 may implicitly determine the first identity of the first BSR or first delay budget and the second identity of the second BSR or second delay budget based on the information. For example, the identity may be implicitly determined based the order of the BSR or delay budget in the information, i.e., the first BSR or the first delay budget in the information is associated with the first identity, and the second BSR or the second delay budget in the information is associated with the second identity. In an embodiment, the information may indicate a second BSR of the second set of data packets, but does not indicate delay budget associated with the second BSR. In this case, there may be no delay budget requirement on the second set of data packets.

In some embodiments, the first delay budget or the second delay budget can also be associated with a logical channel group (LCG) ID or a logical channel (LCH) ID. In this case, the first delay budget or the second delay budget may be applied to all the data packets in the buffer of the associated LCG/LCH, respectively.

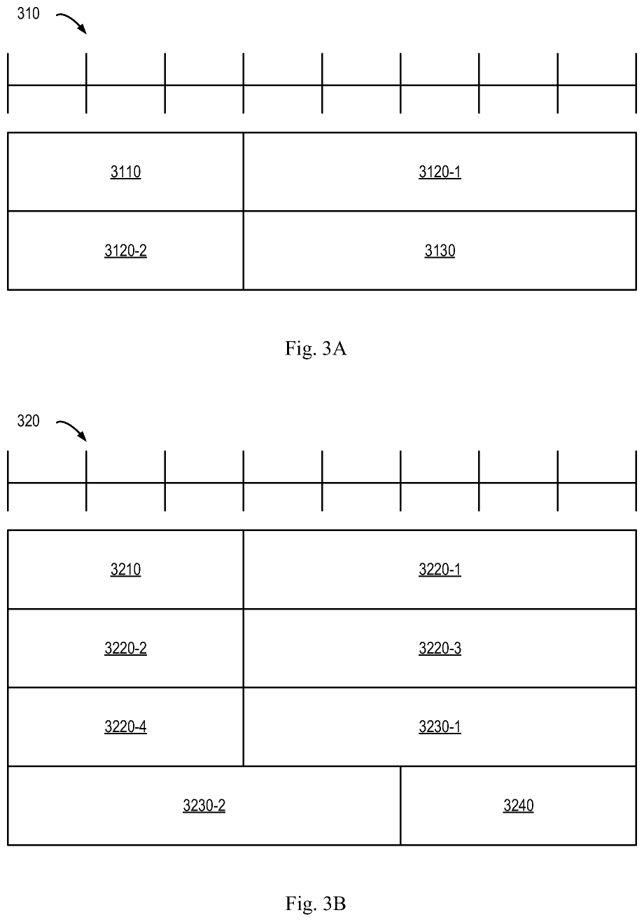

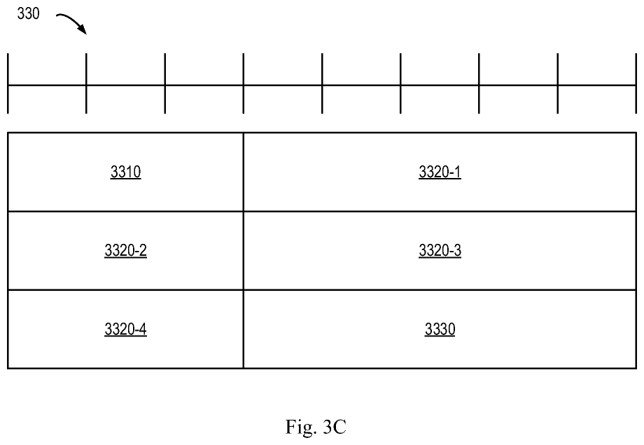

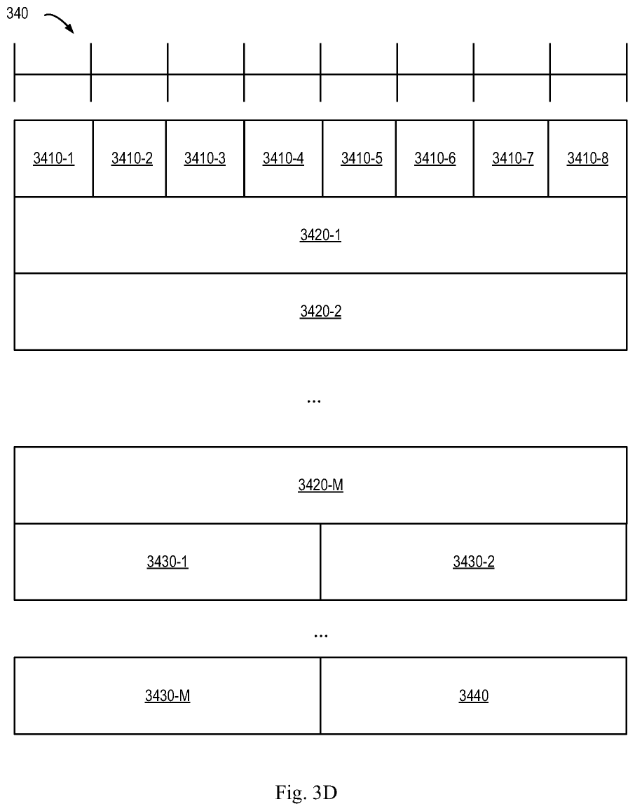

FIGS. 3A-3E show block diagrams of BSR MAC-CE according to some example embodiments of the present disclosure, respectively. It should be noted that the BSR MAC-CEs shown in FIGS. 3A-3E are only examples not limitations. For example, the order of the fields shown in FIGS. 3A-3E are examples, the fields can be in any proper order. The BSR MAC-CEs in FIGS. 3A-3E may also comprise other fields which are not shown in those figures. In particular, FIGS. 3A-3C show structures of short BSR and FIGS. 3D and 3E show structures of long BSR. As shown in FIGS. 3A-3C, for a short BSR, 8 bits may be used for the buffer size and a new delay budget field is introduced. For example, as illustrated in FIG. 3A, the BSR MAC CE 310 may indicate only one BSR and its delay budget. The BSR MAC CE 310 may have a LCG ID field 3110, buffer size fields 3120-1 and 3120-2 for the BSR, and a delay budget field 3130. As shown in FIG. 3B, the BSR MAC CE 320 may indicate two BSRs and their delay budgets. In this case, the BSR MAC CE 320 may have a LCG ID field 3210, buffer size fields 3220-1 and 3220-2 for a BSR, buffer size fields 3220-3 and 3220-4 for another BSR, a delay budget field 3230-1 for a delay budget, a delay budget field 3230-2 for another delay budget, and a reserved field 3240. As shown in FIG. 3C, the BSR MAC CE 330 may indicate two BSRs and only one of them has a delay budget. In this case, the BSR MAC CE 330 may have a LCG ID field 3310, buffer size fields 3320-1 and 3320-2 for a BSR, buffer size fields 3320-3 and 3320-4 for another BSR, a delay budget field 3330 for a delay budget. The delay budget indicated by the delay budget field 3330 can be pre-defined or configured to associate with the first BSR indicated by the buffer size fields 3320-1 or the second BSR indicated by buffer size fields 3320-2. As an example, in FIGS. 3A-3C, the delay budget fields 3130, 3230-1, 3230-2 and 3330 all have 5 bits, and the reserved field 3240 has 3 bits.

As shown in FIGS. 3D and 3E, for a long BSR, m budget delay values may be associated with m buffer size values, respectively. As shown in FIG. 3D, the m is an odd number. The BSR MAC CE 340 may comprise LCG ID fields 3410-1, 3410-2, 3410-3, 3410-4, 3410-5, 3410-6, 3410-7 and 3410-8, buffer size fields 3420-1, 3420-2, . . . , and 3420-m, delay budget fields 3430-1, 3430-2, . . . , and 3430-m which are associated with buffer size fields 3420-1, 3420-2, . . . , and 3420-m respectively, and a reserved field 3440. As shown in FIG. 3E, the m is an even number. The BSR MAC CE 350 may comprise LCG ID fields 3510-1, 3510-2, 3510-3, 3510-4, 3510-5, 3510-6, 3510-7 and 3510-8, buffer size fields 3520-1, 3520-2, . . . , and 3520-m, delay budget fields 3530-1, 3530-2, . . . , 3530-(m−1), and 3530-m which are associated with the buffer size fields 3520-1, 3520-2, . . . , and 3520-m respectively. As an example, in FIGS. 3D and 3E, the delay budget fields 3430-1, 3430-2, . . . , 3430-m and 3530-1, 3530-2, . . . , 3530-(m−1), 3530-m all have 4 bits, and the reserved field 3440 has 4 bits.

Referring back to FIG. 2, the terminal device 110-1 may transmit 2040 a second indication to the network device 120. The second indication may indicate whether at least a portion of the first set of data packets associated the first BSR or the first delay budget can be dropped. In some embodiments, the second indication may indicate that the at least one portion of the first set of data packets can be dropped. In this case, the network device 120 may drop the at least one portion of the first set of data packets. Alternatively, the second indication may indicate that the at least one portion of the first set of data packets cannot be dropped. In this case, the network device 120 needs to transmit remaining data packets in the first set of data packets, even though the remaining data packets cannot be transmitted before the end of the first delay budget.

In other embodiments, the network device 120 may determine 2050 whether to drop at least a portion of the first set of data packets based on the first delay budget. In some embodiments, the network device 120 may determine whether to drop the at least one portion of the first set of data packets based on whether the at least one portion of the first set of data packets are able to be transmitted within the first delay budget. For example, if the at least one portion of the first set of data packets cannot be transmitted successfully, the network device 120 may determine to drop the at least one portion of the first set of data packets. In an example embodiment, the successful transmission of a set of data packets may refer to that all or at least a certain percentage of the set of data packets have been transmitted to the network device 120. In another embodiment, the successful transmission of a set of data packets may refer to that all or at least a certain percentage of the set of data packets have been correctly transmitted to the network device 120.

Alternatively, if the at least one portion of the first set of data packets can be transmitted successfully, the network device 120 may determine not to drop the at least one portion of the first set of data packets. In other embodiments, the network device 120 may determine whether to drop the at least one portion of the first set of data packets based on a higher layer indication. For example, the higher layer indication may an indication from any one of the layers: a MAC layer, a radio link control (RLC) layer, a packet data convergence protocol (PDCP) layer, a RRC layer, or a service data adaption protocol (SDAP) layer. Alternatively, the higher layer indication may be an indication from a non-access stratum (NAS) or from an application layer.

If the network device 120 may determine to drop the at least one portion of the first set of data packets, the network device 120 may transmit 2060 a dropping indication to the terminal device 110-1. The dropping indication may be associated with a XR traffic burst. For example, the dropping indication may comprise an identity associated to this XR traffic burst. In some embodiments, the dropping indication can comprise any one of: a BSR ID, a PDB ID, a LCG ID, or a LCH ID. The dropping indication may be transmitted in a MAC CE. Alternatively, the dropping indication may be transmitted in DCI.

If the terminal device 110-1 receives the dropping indication from the network device 120, the terminal device 110-1 may flush 2070 its buffer associated with the first BSR or associated with the first delay budget. In other words, the terminal device 110-1 may discard the remaining packets associated with the first BSR. The remaining data packets may include at least one data packet in the first set of data packets which are not transmitted to the network device 120 yet, or not correctly transmitted to network device 120 yet. In some embodiments, there may be some data packets in the first set of data packets that are still needed to be transmitted. For example, such data packets may contain some critical control information. In this case, the terminal device 110-1 may transmit a third BSR to the network device 120. The third BSR may indicate a buffer size which includes the data volume of at least one data packet which is needed to be transmitted in the first set of data packets.

For the network device 120, if the scheduler finds it is not possible to assign enough resource to the terminal device 110-1 to transmit the remaining packets successfully before the deadline of PDB, then the network device 120 does not assign UL resource to the terminal device 110-1 for the remaining packets.

According to embodiments described with the reference to FIG. 2, it can avoid wasting resource due to the transmission of out-of-date UL packets. The gNB triggered packet dropping may further reduce the resource wasting, since the scheduler is located at gNB, once gNB decides to drop packet, it will not allocate resource to UE anymore.

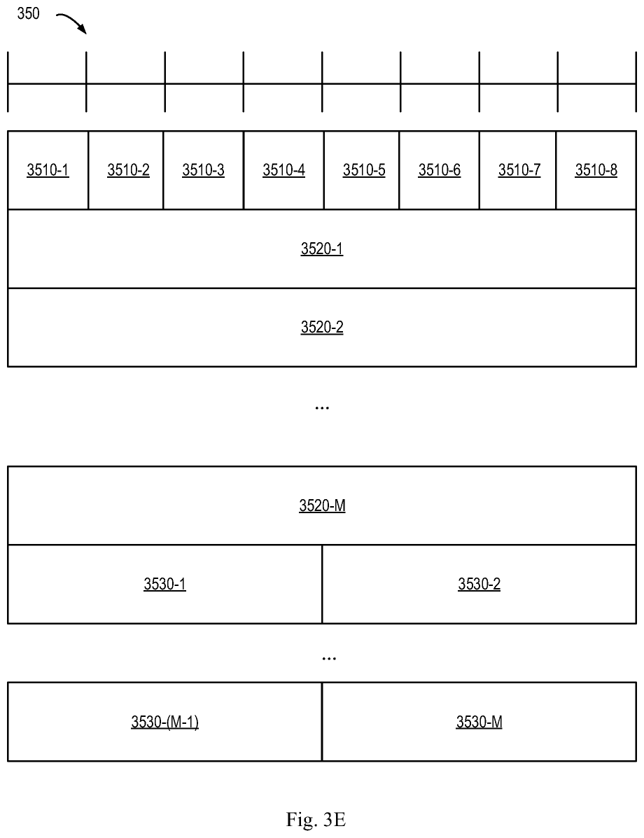

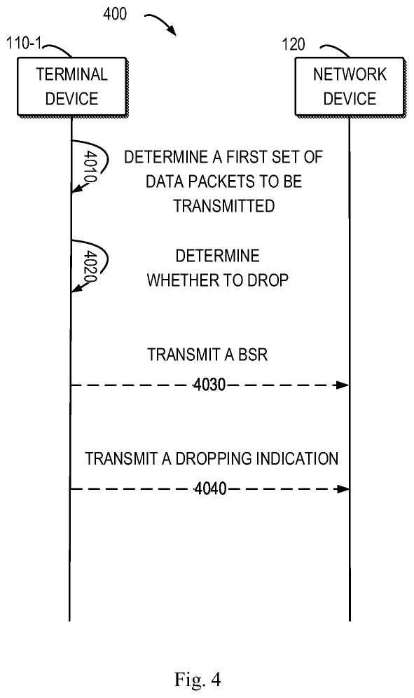

Embodiments of the present disclosure will be described in detail below. Reference is first made to FIG. 4, which shows a signaling chart illustrating process 400 between the terminal device and the network device according to some example embodiments of the present disclosure. Only for the purpose of discussion, the process 400 will be described with reference to FIG. 1. The process 400 may involve the terminal device 110-1 and the network device 120 in FIG. 1.

The terminal device 110-1 determines 4010 a first set of data packets to be transmitted to the network device. The first set of data packets may belong to an XR traffic burst. The first set of data packets may comprise any suitable number of data packets. The terminal device 110-1 may receive the first set of data packets from a higher layer, for example, MAC layer.

The terminal device 110-1 determines 4020 whether to drop a portion of the first set of data packets need to be dropped based on a delay budget for the first set of data packets. In some embodiments, the delay budget may be a PDB. The PDB can represent a delay budget for one or more packets. Alternatively, the delay budget may be an ADU delay budget (ADB). The ADB can represent a delay budget for an ADU.

The terminal device 110-1 may determine the delay budget based on the UL QoS parameters. Alternatively or in addition, the terminal device 110-1 may determine the delay budget based on an arrival time of the first set of data packets and the QoS parameters.

In some embodiments, the network device 120 may transmit a configuration indicating a data size threshold to the terminal device 110-1. In this case, the terminal device 110-1 may determine whether the portion of the first set of data packets need to be dropped based on whether the size of the portion of the first set of data packets exceeds the data size threshold. If the size of the portion of the first set of data packets exceeds the data size threshold, the terminal device 110-1 may determine that the portion of the first set of data packets needs to be dropped. In this situation, an updated BSR will be reported. Alternatively, if the size of the portion of the first set of data packets does not the data size threshold, the terminal device 110-1 may determine that the portion of the first set of data packets do not need to be dropped.

In other embodiments, the network device 120 may transmit a configuration indicating a proportional threshold to the terminal device 110-1. In this case, the terminal device 110-1 may determine whether the portion of the first set of data packets need to be dropped based on whether the portion of the first set of data packets exceeds the proportional threshold. For example, in a situation where the proportional threshold may be Y %, only if more than Y % of the XR traffic burst cannot be transmitted within the delay budget, the data packets may be dropped and an updated BSR may be reported, where Y is a number between 0 and 100.

Alternatively or in addition, the terminal device 110-1 determines 4020 whether to drop a portion of the first set of data packets need to be dropped based on a higher layer indication for the first set of data packets. For example, the higher layer indication may be a NAS signaling. Alternatively, the higher layer indication may be the XR application indication.

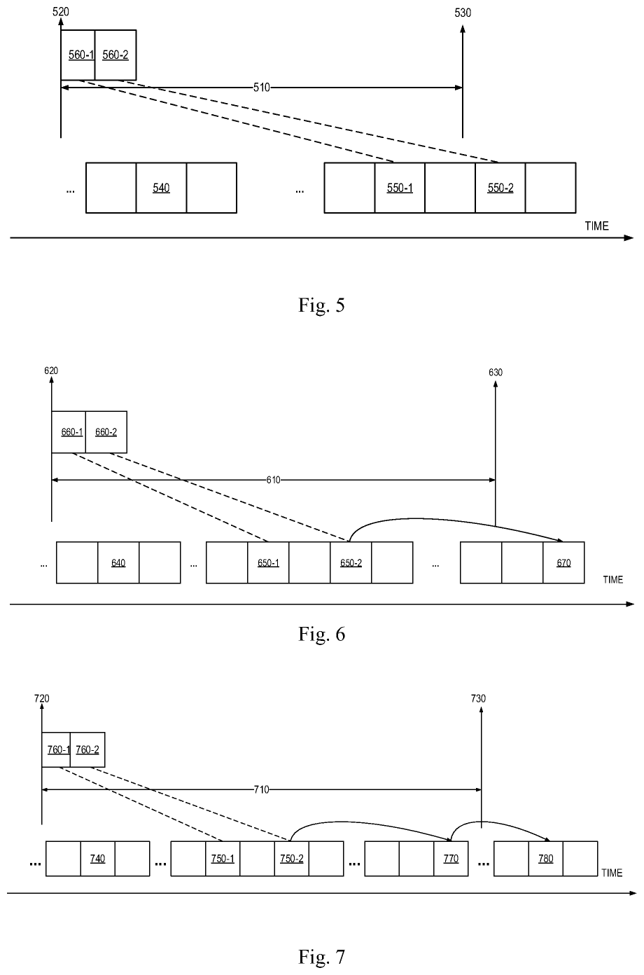

In some embodiments, if the portion of the first set of data packets is not able to be transmitted before a first time instant, the terminal device 110-1 may determine the portion of the first set of data packets to be dropped. The first time instant may be determined based on the delay budget. For example, the terminal device 110-1 can decide to drop the packet no later than the time Td−T1, where Td is the end of the delay budget, and T1 is the shortest required time duration between a physical uplink shared channel (PUSCH) and its scheduling DCI. Only as an example, as shown in FIG. 5, the first set of data packets (for example, the data packets 560-1 and 560-2) arrives at the time instant 520 and the delay budget ends at the time instant 530. The terminal device 110-1 may transmit the BSR in the slot 540 and occasions for the PUSCH transmissions may comprise slots 550-1 and 550-2. As shown in FIG. 5, the data packet 560-1 can be transmitted in slot 550-1 which is within the delay budget duration 510 while the data packet 560-1 needs to be transmitted in slot 550-2 which is out of the delay budget duration 510. In this case, the terminal device 110-1 may determine to drop the data packet 560-2. In an embodiment, the first time instant is the time Td−T1, in another embodiment, the first time instant is the time instant 530.

In other embodiments, if there is at least one hybrid automatic repeat request (HARQ) feedback or at least one new data indicator (NDI) associated with at least one data packet in the portion of the first set of data packets is not able to be received before a second time instant, the terminal device 110-1 may determine the portion of the first set of data packets to be dropped, wherein the second time instant is determined based on the delay budget. For example, the terminal device 110-1 can decide to drop the packet at the time Td−T2, where Td is the end of the delay budget, and T2 is the time that the terminal device 110-1 receives a UL grant that schedule a PUSCH and the corresponding HARQ-ACK is not possible to be sent before the end of the delay budget. Only as an example, as shown in FIG. 6, the first set of data packets (for example, the data packets 660-1 and 660-2) arrives at the time instant 620 and the delay budget ends at the time instant 630. The terminal device 110-1 may transmit the BSR in the slot 640 and occasions for the PUSCH transmissions may comprise slots 650-1 and 650-2. As shown in FIG. 6, the data packet 660-1 can be transmitted in slot 650-1 which is within the delay budget duration 610 and the data packet 660-1 needs to be transmitted in slot 650-2 which is in the delay budget duration 610. However, the occasion for transmitting HARQ feedback of the data packet 660-2 or NDI may be in the slot 670 which is out of the delay budget duration 610. In this case, the terminal device 110-1 may determine to drop the data packet 660-2. In an embodiment, the second time instant is the time Td−T2, in another embodiment, the second time instant is the time instant 630.

In some embodiments, if there is at least one retransmission of at least one data packet in the portion of the first set of data packets is not able to be transmitted before a third time instant, the terminal device 110-1 may determine the portion of the first set of data packets to be dropped, wherein the third time instant is determined based on the delay budget. For example, the terminal device 110-1 can decide to drop the packet at the time Td−T3, where Td is the end of the delay budget, and T3 is the time that the terminal device 110-1 receives a UL grant to schedule a retransmission of a data packet and the retransmission is later than the end of the delay budget. Only as an example, as shown in FIG. 7, the first set of data packets (for example, the data packets 760-1 and 760-2) arrives at the time instant 720 and the delay budget ends at the time instant 730. The terminal device 110-1 may transmit the BSR in the slot 740 and occasions for the PUSCH transmissions may comprise slots 750-1 and 750-2. As shown in FIG. 7, the data packet 760-1 can be transmitted in slot 750-1 which is within the delay budget duration 710 and the data packet 760-1 needs to be transmitted in slot 750-2 which is in the delay budget duration 710. The occasion for transmitting HARQ feedback of the data packet 760-2 or NDI may be in the slot 770. However, the occasion for retransmission of the data packet 760-2 or NDI may be in the slot 780 which is out of the delay budget duration 710. In this case, the terminal device 110-1 may determine to drop the data packet 760-2. In an example embodiment, the third time instant is the time Td−T3, in another embodiment, the third time instant is the time instant 730.

If the terminal device 110-1 determines to drop some data packets in the first set of data packets, the terminal device 110-1 may transmit 4030 a BSR to the network device 120. The BSR may indicate the network device that some of the data packets are dropped. The BSR may indicate remaining data volume of the first set of data packets after the portion of the first set of data packets have been dropped. For example, if the terminal device 110-1 decides to drop some data packets but it still has some data wanted to be transmitted, the BSR report may be transmitted. In an embodiment, if all the remaining data packets in the first set of data packets are determined to be dropped, the terminal device may indicate a BSR with a buffer size of zero.

Alternatively, if the terminal device 110-1 determines to drop all the remaining data packets in the first data packets, the terminal device 110-1 may flush a buffer associated with the first set of data packets. In other words, the terminal device 110-1 may discard the remaining packets associated with the first BSR. The remaining data packets in the first set of data packets comprise all the data packets in the first set of data packets which are not transmitted to the network device 120 yet. In this case, the terminal device 110-1 may transmit 4040 a dropping indication to the network device 120. The dropping indication may indicate that all the remaining data packets are dropped. In some embodiments, the dropping indication may be transmitted in a MAC CE. Alternatively, the dropping indication may be transmitted in uplink control information (UCI).

In some embodiments, if the terminal device 110-1 still has at least one uplink resource assignment (e.g., a configured grant (CG)-PUSCH or a dynamic grant (DG)-PUSCH which is scheduled before the terminal device 110-1 sends the dropping indication) after the terminal device 110-1 deciding and/or reporting the packet dropping, the terminal device 110-1 may skip this resource assignment (i.e., not transmit in the assigned resource), and the network device 120 may schedule other UEs to utilize these resource.

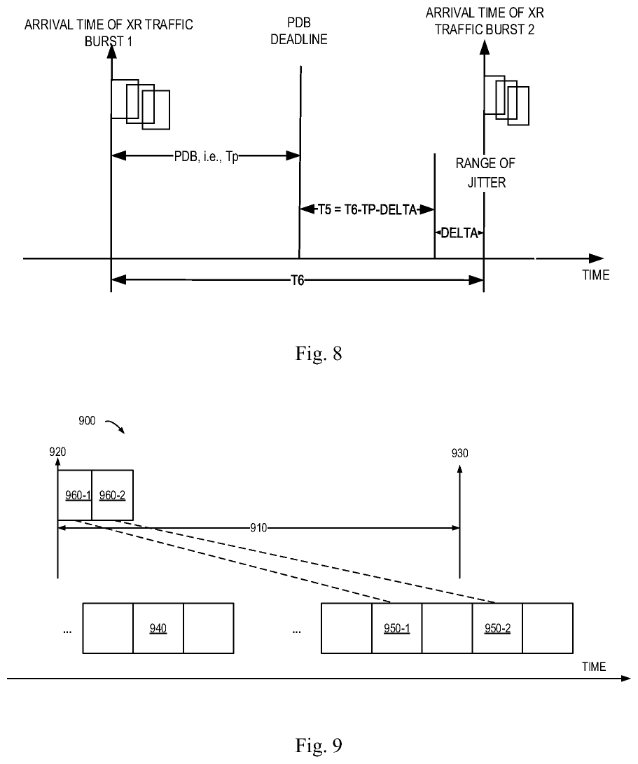

In some embodiments, only the resource within a time window can be dropped, e.g., a time window from T4 to T5, T4 and T5 are integer number of OFDM symbols or number of millisecond after the terminal device 110-1 sending the dropping indication or after the end of delay budget, and T4 can be zero, T5 can be the time instant of the end of delay budget. For dynamic scheduling, if the UL grant is received before the terminal device 110-1 sending the dropping indication and the scheduled PUSCH is after UE sending the dropping indication, the associated PUSCH may be skipped. For configured grant, the CG-PUSCH occasions in the time window from T4 to T5 may be skipped. Optionally, T5 can be (T6−Tp−delta), where T6 is the periodicity of CG configuration, or the time interval between two XR traffic bursts (e.g., equals to 1/FPS second, where FPS stands for Frames Per Second, and FPS is 30/60/90/120), Tp is the maximum delay budget, delta is a value configured by gNB (optionally, delta can accommodate the jitter of arrival time). For example, FIG. 8 shows a situation where assumes T4=0 after the end of delay budget. Rang of jitter means the range of the potential XR burst arrival time, the exact arrival time is unpredictable before the packet arrives, but it will not exceed the range. For the case jitter is considered, T6 may be the time interval between two adjacent XR traffic bursts on average. For the case jitter does not exist or is ignored, T6 may be the time interval between two adjacent XR traffic bursts, and delta may be zero.

In some embodiments, the cancelled PUSCH may be intended for an initial transmission of a dropped data packet. Only as an example, as shown in FIG. 9, the first set of data packets (for example, the data packets 960-1 and 960-2) arrives at the time instant 9520 and the delay budget ends at the time instant 5930. As shown in FIG. 9, the data packet 960-1 is scheduled or configured to be transmitted in a PUSCH in slot 950-1 which is within the delay budget duration 910, while the data packet 960-2 is scheduled or configured to be transmitted in a PUSCH in slot 950-2, however, the slot 950-2 already exceed the end of delay budget. In this case, the terminal device 110-1 may determine to skip the PUSCH transmission in slot 950-2.

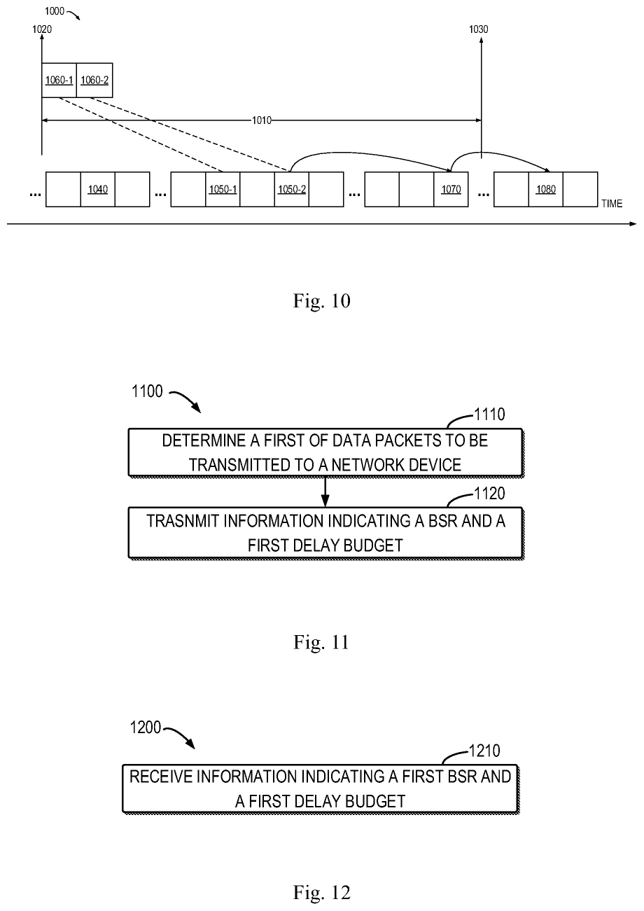

In some embodiments, the cancelled PUSCH may be intended for a re-transmission of a dropped data packet. Only as an example, as shown in FIG. 10, the first set of data packets (for example, the data packets 1060-1 and 1060-2) arrives at the time instant 1020 and the delay budget ends at the time instant 1030. As shown in FIG. 10, the data packet 1060-1 is scheduled or configured to be transmitted in a PUSCH in slot 1050-1 which is within the delay budget duration 1010 and the data packet 1060-1 is scheduled or configured to be transmitted in a PUSCH in slot 1050-2 which is in the delay budget duration 1010. The occasion for receiving a HARQ-ACK or a NDI associated with the data packet 1060-2 may be in the slot 1070. However, if a retransmission is indicated and the occasion for retransmission of the data packet 1060-2 may be in the slot 1080 which is out of the delay budget duration 1010. In this case, the terminal device 110-1 may determine to skip the PUSCH in slot 1080.

According to embodiments described with the reference to FIG. 4, it can avoid wasting resource due to the transmission of out-of-date UL packets. The UE triggered packet dropping may be more precise since UE has more precise information of the UL traffic. It is beneficial to avoid wrong decisions, which may cause degradation of user experience.

In some embodiments, the packet dropping can also be achieved without explicit dropping indication. In other words, the terminal device 110-1 and the network device 120 can determine whether to drop data packets in the first set of data packets independently. In this way, the implicit packet dropping method can save signaling overhead. For example, the terminal device 110-1 and the network device 120 can determine whether the packets should be dropped based on a pre-configured dropping rule. By way of example, for the terminal device 110-1, if it finds there are not enough UL resources been scheduled or configured to transmit the remaining packets successfully before the end of delay budget, then the terminal device 110-1 may decide to drop the remaining packets (i.e., flush the buffer). For the network device 120, if the scheduler finds it is not able to assign enough resource to the terminal device 110-1 to transmit the remaining packets successfully before the end of delay budget, then the network device 120 does not assign UL resource to the UE for the remaining data packets. Therefore, there is no explicit dropping indication sent by gNB or UE.

FIG. 11 shows a flowchart of an example method 1100 in accordance with an embodiment of the present disclosure. The method 1100 can be implemented at any suitable devices. Only for the purpose of illustrations, the method 1100 can be implemented at a terminal device 110-1 as shown in FIG. 1.

At block 1110, the terminal device 110-1 determines a first set of data packets to be transmitted to a network device 120. The first set of data packets may belong to an XR traffic burst or an ADU. The first set of data packets may comprise any suitable number of data packets. The terminal device 110-1 may receive the first set of data packets from a higher layer, for example, MAC layer. In some embodiments, the data packet may be an ADU. Alternatively, the data packet may be an internet protocol (IP) packet. The data packet may be a radio link control (RLC) protocol data unit. Alternatively, the data packet may be a RLC service data unit (SDU). In other embodiments, the data packet may be a MAC PDU or a MAC SDU. The data packet may also be a transport block (TB). In addition, the data packet may be a code block group (CBG). In some embodiments, the data packet may be a scheduling unit.

At block 1120, the terminal device 110-1 transmits, to the network device 120, information indicating: a first buffer status report (BSR) of the first set of data packets and a first delay budget associated with the first BSR. The first BSR may indicate the data volume of the first set of data packets. In addition, the information indicates a first delay budget associated with the first BSR. The first delay budget may be a remaining delay budget for the first set of data packets. The remaining delay budget for the first set of data packets may be the time duration from the time that the information is transmitted to the latest time that the first set of data packets are expected to be successfully transmitted. The information may be transmitted in a MAC CE. The time that the information is transmitted is the time of the first symbol or last symbol of a transmission which contains the information. In addition, the first set of data packets may be transmitted in a logical channel.

In some embodiments, the terminal device 110-1 may determine a second set of data packets to be transmitted to the network device. In this case, the terminal device 110-1 may transmit the information further indicating: a second BSR of the second set of data packets and a second delay budget associated with the second BSR. The second delay budget may be a remaining delay budget for the second set of data packets. The remaining delay budget for the second set of data packets may be the time duration from the time that the information is transmitted to the latest time that the second set of data packets are expected to be successfully transmitted.

In some embodiments, the information may indicate a first identity of the first BSR or the first delay budget. Alternatively or in addition, the information may indicate a second identity of the second BSR or the second delay budget.

In some embodiments, the terminal device 110-1 may receive, from the network device 120, a first indication for transmitting the first delay budget.

In some embodiments, the terminal device 110-1 may transmit, to the network device 120, a second indication regarding whether at least a portion of the first set of data packets associated with the first BSR or the first delay budget can be dropped. In some embodiments, the second indication may indicate that the at least one portion of the first set of data packets can be dropped. In this case, the network device 120 may drop the at least one portion of the first set of data packets. Alternatively, the second indication may indicate that the at least one portion of the first set of data packets cannot be dropped. In this case, the network device 120 needs to transmit remaining data packets in the first set of data packets, even though the remaining data packets cannot be transmitted before the end of the first delay budget. In some embodiments, the information comprises a logical channel group identity or a logical channel identity.

In some embodiments, the terminal device 110-1 may receive, from the network device 120, a dropping indication associated with the first BSR or the first delay budget. In this case, the terminal device 110-1 may flush a buffer associated with the first BSR or the first delay budget based on the dropping indication.

In some embodiments, the terminal device 110-1 may transmit a third BSR to the network device 120, wherein the third BSR is associated with at least one data packet in the first set of data packets.

FIG. 12 shows a flowchart of an example method 1200 in accordance with an embodiment of the present disclosure. The method 1200 can be implemented at any suitable devices. Only for the purpose of illustrations, the method 1200 can be implemented at a network device 120 as shown in FIG. 1.

At block 1210, the network device 120 receives, from a terminal device 110-1, information indicating: a first buffer status report (BSR) of a first set of data packets and a first delay budget associated with the first BSR. The first set of data packets are to be transmitted by the terminal device. In some embodiments, the network device 120 may receive the information further indicating: a second BSR of a second set of data packets and a second delay budget associated with the second BSR, wherein the second set of data packets are to be transmitted by the terminal device. In this case, the network device 120 may determine a first identity of the first BSR or the first delay budget and a second identity of the second BSR or the second delay budget based on the information.

In some embodiments, the network device 120 may transmit, to the terminal device 110-1, a first indication for transmitting the first delay budget. In some embodiments, the network device 120 may receive a second indication regarding whether at least a portion of the first set of data packets associated with the first BSR or the first delay budget can be dropped. In some embodiments, the second indication may indicate that the at least one portion of the first set of data packets can be dropped. In this case, the network device 120 may drop the at least one portion of the first set of data packets. Alternatively, the second indication may indicate that the at least one portion of the first set of data packets cannot be dropped. In this case, the network device 120 needs to transmit remaining data packets in the first set of data packets, even though the remaining data packets cannot be transmitted before the end of the first delay budget.

In some embodiments, the information comprises a logical channel group identity or a logical channel identity.

In some embodiments, the network device 120 may determine whether to drop at least one portion of the first set of data packets based on the first delay budget. In this case, if the at least one portion of the first set of data packets are to be dropped, the network device 120 may transmit, to the terminal device 110-1, a dropping indication associated with the first BSR or the first delay budget.

In some embodiments, the network device 120 may determine whether to drop the at least one portion of the first set of data packets based on one of: whether the at least one portion of the first set of data packets are able to be transmitted within in the first delay budget, or a higher layer indication.

In some embodiments, the network device 120 may determine the first delay budget based on the information; or determine the first delay budget based on an uplink Quality of Service (QoS) parameter.

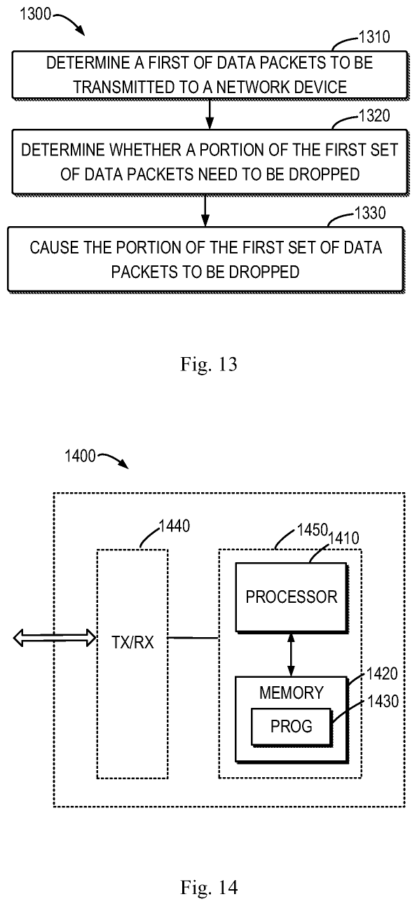

FIG. 13 shows a flowchart of an example method 1300 in accordance with an embodiment of the present disclosure. The method 1300 can be implemented at any suitable devices. Only for the purpose of illustrations, the method 1300 can be implemented at a terminal device 110-1 as shown in FIG. 1.

At block 1310, the terminal device 110-1 determines a first set of data packets to be transmitted to a network device.

At block 1320, the terminal device 110-1 determines whether a portion of the first set of data packets need to be dropped based on a delay budget or a higher layer indication for the first set of data packet.

At block 1330, if the portion of the first set of data packets need to be dropped, the terminal device 110-1 causes the portion of the first set of data packets to be dropped. In some embodiments, the terminal device 110-1 may determine the delay budget based on an arrival time of the first set of data packets and a quality of service parameter.

In some embodiments, if the portion of the first set of data packets is not able to be transmitted before a time instant, the terminal device 110-1 may determine the portion of the first set of data packets to be dropped, wherein the time instant is determined based on the delay budget. In some embodiments, if there is at least one hybrid automatic repeat request (HARQ) feedback or at least one new data indicator (NDI) associated with at least one data packet in the portion of the first set of data packets is not able to be received before a time instant, the terminal device 110-1 may determine the portion of the first set of data packets to be dropped, wherein the time instant is determined based on the delay budget.

In some embodiments, if there is at least one retransmission of at least one data packet in the portion of the first set of data packets is not able to be transmitted before a time instant, the terminal device 110-1 may determine the portion of the first set of data packets to be dropped, wherein the time instant is determined based on the delay budget.

In some embodiments, the terminal device 110-1 may receive, from the network device 120, a configuration indicating a data size threshold. In this case, the terminal device 110-1 may determine whether the portion of the first set of data packets need to be dropped based on whether the size of the portion of the first set of data packets exceeds the data size threshold.

In some embodiments, the terminal device 110-1 may receive, from the network device 120, a configuration indicating a proportional threshold. In this case, the terminal device 110-1 may determine whether the portion of the first set of data packets need to be dropped based on whether the portion of the first set of data packets exceeds the proportional threshold.

In some embodiments, the terminal device 110-1 may transmit, to the network device 120, a BSR indicating remaining data volume of the first set of data packets after the portion of the first set of data packets have been dropped.

In some embodiments, if all the remaining data packets in the first set of data packets need to be dropped, the terminal device 110-1 may flush a buffer associated with the first set of data packets. The terminal device 110-1 may further transmit, to the network device 120, a dropping indication to indicate that all the remaining data packets in the first set of data packets are dropped.

In some embodiments, if there is an uplink transmission occasion after the determination of dropping the portion of the first set of data packets, the terminal device 110-1 may cause the uplink transmission occasion to be skipped.

In some embodiments, a terminal device comprises circuitry configured to determine a first set of data packets to be transmitted to a network device; and transmit, to the network device, information indicating: a first buffer status report (BSR) of the first set of data packets and a first delay budget associated with the first BSR.

In some embodiments, the terminal device comprises circuitry further configured to receive, from the network device, a first indication for transmitting the first delay budget.

In some embodiments, the terminal device comprises circuitry further configured to determine a second set of data packets to be transmitted to the network device. The terminal device comprises the circuitry configured to transmit the information by transmitting the information further indicating: a second BSR of the second set of data packets and a second delay budget associated with the second BSR.

In some embodiments, the information indicates a first identity of the first BSR or the first delay budget, and a second identity of the second BSR or the second delay budget.

In some embodiments, the terminal device comprises circuitry further configured to transmit, to the network device, a second indication regarding whether at least a portion of the first set of data packets can be dropped, wherein the first set of data packets is associated with the first BSR or the first delay budget.

In some embodiments, the information comprises a logical channel group identity or a logical channel identity.

In some embodiments, the terminal device comprises circuitry further configured to receive, from the network device, a dropping indication associated with the first BSR or the first delay budget; and flush a buffer associated with the first BSR or the first delay budget based on the dropping indication.

In some embodiments, the terminal device comprises circuitry further configured to transmit a third BSR to the network device, wherein the third BSR is associated with at least one data packet in the first set of data packets, and wherein the at last one data packet needs to be transmitted.

In some embodiments, a network device comprises circuitry configured to receive, from a terminal device, information indicating: a first buffer status report (BSR) of a first set of data packets and a first delay budget associated with the first BSR. The first set of data packets are to be transmitted by the terminal device.

In some embodiments, the network device comprises circuitry further configured to transmit, to the terminal device, a first indication for transmitting the first delay budget.

In some embodiments, the network device comprises circuitry configured to receive the information by: receiving the information further indicating: a second BSR of a second set of data packets and a second delay budget associated with the second BSR. The second set of data packets are to be transmitted by the terminal device.

In some embodiments, the network device comprises circuitry configured to determine a first identity of the first BSR or the first delay budget and a second identity of the second BSR or the second delay budget based on the information.

In some embodiments, the network device comprises circuitry configured to receive a second indication regarding whether at least a portion of the first set of data packets associated with the first BSR or the first delay budget can be dropped.

In some embodiments, the information comprises a logical channel group identity or a logical channel identity.

In some embodiments, the network device comprises circuitry configured to determine whether to drop at least one portion of the first set of data packets based on the first delay budget; and in accordance with a determination that the at least one portion of the first set of data packets are to be dropped, transmit, to the terminal device, a dropping indication associated with the first BSR or the first delay budget.

In some embodiments, the network device comprises circuitry configured to determine whether to drop the at least one portion of the first set of data packets by: determining whether to drop the at least one portion of the first set of data packets based on one of: whether the at least one portion of the first set of data packets are able to be transmitted within in the first delay budget, or a higher layer indication.

In some embodiments, the network device comprises circuitry configured to determine the first delay budget based on the information; or determine the first delay budget based on an uplink Quality of Service (QoS) parameter.

In some embodiments, a terminal device comprises circuitry configured to determine, at a terminal device, a first set of data packets to be transmitted to a network device; in accordance with a determination that a portion of the first set of data packets needs to be dropped based on a delay budget or a higher layer indication for the first set of data packets, cause the portion of the first set of data packets to be dropped.

In some embodiments, the terminal device comprises circuitry further configured to determine the delay budget based on an arrival time of the first set of data packets and a quality of service parameter.

In some embodiments, the terminal device comprises circuitry further configured to determine whether the portion of the first set of data packets need to be dropped based on the delay budget for the first set of data packets by: in accordance with a determination that the portion of the first set of data packets is not able to be transmitted before a time instant, determining the portion of the first set of data packets to be dropped wherein the time instant is determined based on the delay budget.

In some embodiments, the terminal device comprises circuitry further configured to determine whether the portion of the first set of data packets need to be dropped based on the delay budget for the first set of data packets by: in accordance with a determination that the portion of the first set of data packets is not able to be transmitted before a time instant, determining the portion of the first set of data packets to be dropped, wherein the time instant is determined based on the delay budget.

In some embodiments, the terminal device comprises circuitry further configured to determine whether the portion of the first set of data packets need to be dropped based on the delay budget for the first set of data packets by: in accordance with a determination that there is at least one hybrid automatic repeat request (HARQ) feedback or at least one new data indicator (NDI) associated with at least one data packet in the portion of the first set of data packets is not able to be received before a time instant, determining the portion of the first set of data packets to be dropped, wherein the time instant is determined based on the delay budget.

In some embodiments, the terminal device comprises circuitry further configured to determine g whether the portion of the first set of data packets need to be dropped based on the delay budget for the first set of data packets by: in accordance with a determination that there is at least one retransmission of at least one data packet in the portion of the first set of data packets is not able to be transmitted before a time instant, determining the portion of the first set of data packets to be dropped, wherein the time instant is determined based on the delay budget.

In some embodiments, the terminal device comprises circuitry further configured to receive, from the network device, a configuration indicating a data size threshold; and determine whether the portion of the first set of data packets need to be dropped based on whether the size of the portion of the first set of data packets exceeds the data size threshold.

In some embodiments, the terminal device comprises circuitry further configured to receive, from the network device, a configuration indicating a proportional threshold; and determine whether the portion of the first set of data packets need to be dropped based on whether the portion of the first set of data packets exceeds the proportional threshold.

In some embodiments, the terminal device comprises circuitry further configured to transmit, to the network device, a BSR indicating remaining data volume of the first set of data packets after the portion of the first set of data packets have been dropped.

In some embodiments, the terminal device comprises circuitry further configured to in accordance with a determination that all the remaining data packets in the first set of data packets need to be dropped, flush a buffer associated with the first set of data packets; and transmit, to the network device, a dropping indication to indicate that all the remaining data packets in the first set of data packets are dropped.

In some embodiments, the terminal device comprises circuitry further configured to in accordance with a determination that there is an uplink transmission occasion after the determination of dropping the portion of the first set of data packets, cause the uplink transmission occasion to be skipped.

FIG. 14 is a simplified block diagram of a device 1400 that is suitable for implementing embodiments of the present disclosure. The device 1400 can be considered as a further example implementation of the terminal device 110 and the network device 120 as shown in FIG. 1. Accordingly, the device 1000 can be implemented at or as at least a part of the terminal device 110 or the network device 120.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1420 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1430 is assumed to include program instructions that, when executed by the associated processor 1410, enable the device 1400 to operate in accordance with the embodiments of the present disclosure, as discussed herein with reference to FIGS. 2 to 14. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1550 adapted to implement various embodiments of the present disclosure.

The memory 1420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A method of communication performed by user equipment (UE), comprising:
transmitting, to a network device, information which indicates a first amount of first set of uplink data to be transmitted and a first remaining delay budget associated with the first amount of the first set of uplink data.

32. The method of claim 31, wherein the first remaining delay budget is related to a time duration from a time that the information is transmitted to a latest time that the first set of uplink data are expected to be successfully transmitted.

33. The method of claim 31, wherein the information is transmitted in a MAC CE.

34. The method of claim 31 further comprising:
discarding the first set of uplink data, if a portion of the first set of uplink data is not able to be transmitted due to the first remaining delay budget.

35. The method of claim 31, further comprising:
receiving, from the network device, a first indication for transmitting the information.

36. The method of claim 31, wherein the information further indicates a second amount of second set of uplink data to be transmitted and a second remaining delay budget associated with the second amount of the second set of uplink data.

37. The method of claim 36, wherein the information comprises a first identity of the first set of uplink data or the first remaining delay budget, and a second identity of the second set of uplink data or the second remaining delay budget.

38. The method of claim 31, further comprising:
transmitting, to the network device, a second indication regarding whether at least a portion of the first set of uplink data can be dropped.

39. The method of claim 31, wherein the information comprises a logical channel group identity or a logical channel identity.

40. The method of claim 31, further comprising:
receiving, from the network device, a dropping indication associated with the first set of uplink data or the first remaining delay budget; and
flushing a buffer associated with the first set of uplink data or the first remaining delay budget based on the dropping indication.

41. A method of communication performed by network device, comprising:
receiving, from a user equipment (UE), information which indicates a first amount of first set of uplink data to be transmitted and a first remaining delay budget associated with the first amount of the first set of uplink data.

42. The method of claim 41, wherein the first remaining delay budget is related to a time duration from a time that the information is transmitted to a latest time that the first set of uplink data are expected to be successfully transmitted.

43. The method of claim 41, wherein the information is transmitted in a MAC CE.

44. The method of claim 41, further comprising:
transmitting, to the UE, a first indication for transmitting the information.

45. The method of claim 41, wherein the information further indicates a second amount of second set of uplink data to be transmitted and a second remaining delay budget associated with the second amount of the second set of uplink data.

46. The method of claim 45, wherein the information comprises a first identity of the first set of uplink data or the first remaining delay budget and a second identity of the second set of uplink data or the second remaining delay budget.

47. The method of claim 41, further comprising: receiving a second indication regarding whether at least a portion of the first set of uplink data can be dropped.

48. The method of claim 41, wherein the information comprises a logical channel group identity or a logical channel identity.

49. The method of claim 41, further comprising:
determining whether to drop at least one portion of the first set of uplink data based on the first delay budget; and
in accordance with a determination that the at least one portion of the first set of uplink data are to be dropped, transmitting, to the UE, a dropping indication associated with the first set of uplink data or the first remaining delay budget.

50. The method of claim 49, wherein determining whether to drop the at least one portion of the first set of uplink data comprises:
determining whether to drop the at least one portion of the first set of uplink data based on one of: whether the at least one portion of the first set of uplink data are able to be transmitted within in the first remaining delay budget, or a higher layer indication.

51. The method of claim 41, further comprising:
determining the first remaining delay budget based on the information; or determining the first remaining delay budget based on an uplink Quality of Service (QoS) parameter.

52. A non-transitory computer readable medium having instructions stored thereon, the instructions, when executed on at least one processor, causing the at least one processor to perform the method according to claim 31.

53. A user equipment (UE), comprising:
at least one processor configured to execute instructions that when executed cause the UE to perform operations comprising:
transmitting, to a network device, information which indicates a first amount of first set of uplink data to be transmitted and a first remaining delay budget associated with the first amount of the first set of uplink data.

54. The UE of claim 53, wherein the first remaining delay budget is related to a time duration from a time that the information is transmitted to a latest time that the first set of uplink data are expected to be successfully transmitted.

55. The UE of claim 53, wherein the information is transmitted in a MAC CE.

56. The UE of claim 53, wherein the operations further comprise:
discarding the first set of uplink data, if a portion of the first set of uplink data is not able to be transmitted due to the first remaining delay budget.
